(19) United States
(12) Patent Application Publication
(10) Pub. No.: US 2020/0071962 A1
(43) Pub. Date: Mar. 5, 2020

(54) FOOT ACTUATED DOOR LATCH APPARATUS

(71) Applicant: LUKE MARKWAY, JEFFERSON CITY, MO (US)

(72) Inventor: LUKE MARKWAY, JEFFERSON CITY, MO (US)

(21) Appl. No.: 16/555,024

(22) Filed: Aug. 29, 2019

Related U.S. Application Data
(60) Provisional application No. 62/725,794, filed on Aug. 31, 2018.

(51) Int. Cl. E05B 53/00; E05B 47/00; E05B 1/00; E05F 11/54; E05F 13/02

(52) U.S. Cl. CPC E05B 53/001; E05B 47/0001; E05F 13/02; E05F 11/54; E05B 1/0046

(57) ABSTRACT

A foot-actuated door latch apparatus having a mounting bracket attached to the face of the door near the base and proximate the door jamb. The apparatus has an elongated, horizontal slide track formed in the mounting bracket, and a matching slide bolt nested in the slide track, the slide bolt and said slide track configured for the slide bolt to travel horizontally in the slide track between a first position and a second position. The slide bolt extending from the mounting bracket and engaging the jamb detent when the door is substantially closed and the slide bolt is positioned in the first position. The slide bolt being disengaged from the jamb detent when the slide bolt is positioned in said second position. The actuation portion urging the slide bolt between the first and second positions.

### CROSS-REFERENCE TO RELATED APPLICATIONS

This application claims the benefit of U.S. Provisional Application No. 62/725794, filed Aug. 31, 2018, which U.S. provisional application is incorporated herein by reference.

### STATEMENT REGARDING FEDERALLY SPONSORED RESEARCH OR DEVELOPMENT

Not Applicable.

### BACKGROUND OF THE INVENTION

The present invention is related generally to devices for the opening, closing and latching of doors without the use of hands, and more specifically, to a novel door opening, closing and latching device that allows for the latching and/or unlatching and the opening and/or closing of a door, all by foot actuation without requiring the foot to engage the door itself or engage a traditional door handle or knob. It is contemplated that the device can alternatively be used in conjunction with a foot-actuated remote door opening apparatus.

Door openers and latches are very old in the art, and many configurations of door opening and closure devices exist that are currently available to the public. These include for example, various latches, handles, grips, knobs, locks, and hooks. Each of these devices has its own manner of engagement with the door to allow the opening of the door, and nearly all of these devices require the use of one or both of a person's hands. For example, handles, grips and knobs all require the user to grasp the device with one or both hands, and in some cases manipulate the device or the door with the hand or hands, to open the door. Yet, occasions can and do arise in which a door will need to be latched or unlatched and opened or closed without using a hand. For example, when both hands are carrying items, when one or more of the hands or arms are injured, when the hands are dirty or soiled, or when the door is damaged or heated as from a fire and cannot be touched by hand. It is also desirable to enable the latching and opening of a door without the use of hands when the spread of germs or other contagions or pathogens is of concern, or to enable a disabled individual who has limited functionality of the hands to open the door. Other such circumstances can be readily envisioned that would lead one to desire a mechanism to open or latch a door without the use of hands.

However, while door openers exist that operate to latch or unlatch and open or close a door (for example, through the use of remote sensors, key codes and electronic passkeys), such devices have shortcomings. For example, the remote sensors require additional and sometimes complex electronics in order to operate. Passkeys require the use of a card or other physical device to activate the door, and such physical devices are subject to being lost, stolen or damaged. Further, such devices typically require the use of a hand or both hands to operate the device so as to open or close the door or to latch or unlatch the door. Yet, even when such remote door openers are foot-actuated, it may be desirable to further mechanically latch the door with foot-actuation to ensure the door will remain closed even when remotely “opened.”

A need therefore exists for a compact, uncomplicated door latch and opener that can be easily manipulated with a person's foot to mechanically latch and/or unlatch and/or open and/or close a door.

### BRIEF DESCRIPTION OF THE DRAWINGS

The illustrative embodiments of the present invention are shown in the following drawings which form a part of the specification:

FIG. 1 is an exploded perspective view of a first representative embodiment of the door latch and strike apparatus of the present disclosure, incorporated into a foot-actuated remote door opener;

FIG. 2 is a perspective view of the door latch and strike apparatus of FIG. 1, attached to the base of a door;

FIG. 3 is a side view of the door latch and strike apparatus and associated remote door opener of FIG. 1 attached to the base of a door as in FIG. 2;

FIG. 4 is a partial cross-sectional top view of the door latch and strike apparatus and associated remote door opener of FIG. 1 attached to the base of a door as in FIG. 2, showing the latch engaged with the strike and a user's foot positioned to actuate and open the latch;

FIG. 5 is a partial cross-sectional top view of the door latch and strike apparatus and associated remote door opener of FIG. 1 attached to the base of a door as in FIG. 2, showing the latch disengaged from the strike and a user's foot positioned to actuate and close the latch;

FIG. 6 is a side view of the door latch and strike apparatus and associated remote door opener of FIG. 1 attached to the base of a door as in FIG. 2, showing a first user's foot positioned to actuate the latch and a second user's foot positioned to push against the kick plate opposite the door from the latch;

FIG. 7 is an exploded perspective view of a second representative embodiment of the door latch and strike apparatus of the present disclosure, incorporated into a foot-actuated remote door opener having an integrated kick plate;

FIG. 8 is a side view of the door latch and strike apparatus and associated remote door opener of FIG. 1 attached to the base of a door as in FIG. 7;

FIG. 9 is a partial cross-sectional top view of the door latch and strike apparatus and associated remote door opener of FIG. 7 attached to the base of a door as in FIG. 8, showing the latch engaged with the strike and a user's foot positioned to actuate and open the latch;

FIG. 10 is a partial cross-sectional top view of the door latch and strike apparatus and associated remote door opener of FIG. 7 attached to the base of a door as in FIG. 8, showing the latch disengaged from the strike and a user's foot positioned to actuate and close the latch;

FIG. 11 is a side view of the door latch and strike apparatus and associated remote door opener of FIG. 7 attached to the base of a door as in FIG. 8, showing a first user's foot positioned to actuate the latch and a second user's foot positioned to push against the kick plate opposite the door from the latch;

FIG. 12 is a side view of a third representative embodiment of the door latch and strike apparatus of the present disclosure, attached to the base of a door;

FIG. 13 is a partial cross-sectional top view of the door latch and strike apparatus of FIG. 12 attached to the base of a door as in FIG. 12, showing the latch engaged with the strike and a user's foot positioned to actuate and open the latch;

FIG. 14 is a partial cross-sectional top view of the door latch and strike apparatus of FIG. 12 attached to the base of a door as in FIG. 12, showing the latch disengaged from the strike and a user's foot positioned to actuate and close the latch;

FIG. 15 is a side view of the door latch and strike apparatus of FIG. 12 attached to the base of a door as in FIG. 12, showing a first user's foot positioned to actuate the latch and a second user's foot positioned to push against the kick plate opposite the door from the latch;

FIG. 16 is a side view of a fourth representative embodiment of the door latch and strike apparatus of the present disclosure, having an integrated kick plate and attached to the base of a door;

FIG. 17 is a partial cross-sectional top view of the door latch and strike apparatus of FIG. 16 attached to the base of a door as in FIG. 16, showing the latch engaged with the strike and a user's foot positioned to actuate and open the latch;

FIG. 18 is a partial cross-sectional top view of the door latch and strike apparatus of FIG. 16 attached to the base of a door as in FIG. 16, showing the latch disengaged from the strike and a user's foot positioned to actuate and close the latch;

FIG. 19 is a side view of the door latch and strike apparatus of FIG. 16 attached to the base of a door as in FIG. 16, showing a first user's foot positioned to actuate the latch and a second user's foot positioned to push against the kick plate opposite the door from the latch;

FIG. 20 is a perspective view of a fifth representative embodiment of the door latch and strike apparatus of the present disclosure, incorporated into a foot-actuated remote door opener and attached to the base of a door;

FIG. 21 is a perspective view of a sixth representative embodiment of the door latch and strike apparatus of the present disclosure attached to the base of a door.

Corresponding reference characters indicate corresponding parts throughout the several views of the drawings.

### DETAILED DESCRIPTION OF THE INVENTION

While the invention will be described and disclosed here in connection with certain preferred embodiments, the description is not intended to limit the invention to the specific embodiments shown and described here, but rather the invention is intended to cover all alternative embodiments and modifications that fall within the spirit and scope of the invention as defined by the claims included herein as well as any equivalents of the disclosed and claimed invention.

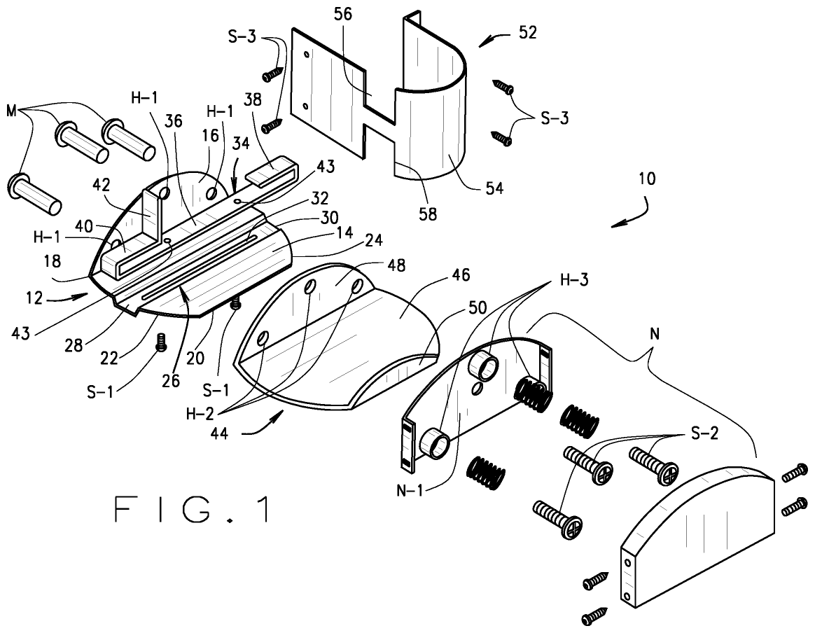

In referring to the drawings, a first representative embodiment of the novel foot-actuated door latch and strike apparatus 10 of the present invention is shown generally in FIGS. 1-6, where the present invention is depicted by way of example configured with an integrated remote door opener N. The door latch and strike apparatus 10 comprises a mounting bracket 12 and three screw mounts M and matching screws S-2, with the screw mounts M and screws S-2 adapted to attach the mounting bracket 12 to a door D positioned in a door jamb J, near the base of the door D and proximate the jamb J. The mounting bracket 12 includes a relatively thin, flat metal base plate 14 and a similarly thin metal rear plate 16. The upper end of the rear plate 16 is generally dome shaped. The mounting bracket 12 has a width of approximately 5 inches and a depth of approximately 3 inches. The mounting bracket 12 has a straight proximal edge 18 on one side of the base plate 14 and a straight distal edge 20 opposite and parallel to the proximal edge 18 on the other side of the base plate 14. A first side edge 22 and a second side edge 24 extend as matching inward sloping convex curves from the distal edge 18 to the proximal edge 20.

A sunken linear rectangular slide track 26 extends across the center of the base plate 14 parallel to the proximal edge 18 and distal edge 20. The track 26 has a uniform width of just over one half inch and a uniform depth of approximately one quarter inch. The track 26 has a first end 28 and a second end 30, with a cut-through linear slot 32 of approximately one quarter inch width formed in the center of the track 26. The slot 32 runs parallel to the proximal edge 18 and distal edge 20, and extends from a point approximately one half inch from the first end 28 to a point approximately one half inch from the second end 30.

The rear plate 16 projects upward from and perpendicular to the proximal edge 18. The rear plate 16 extends the full length of the proximal edge 18 and gradually and uniformly arches upward across its full length to a maximum height at its center point of approximately one and a half inches above the proximal edge 18. A set of three holes H-1 are formed in the rear plate 16 as shown. The holes H-1 each have a diameter that is slightly larger than the shank diameter of the screw mounts M, such that the shanks of the screw mounts M can readily slide into the holes H-1 to secure the rear plate 16 to the door D as can be readily understood.

The door latch and strike apparatus 10 further includes a slide bolt 34 positioned in the track 26. The slide bolt 34 is formed from a strap of rigid metal approximately one half inch wide and one eighth inch thick, with a flat and rectangular lower glide portion 36, a first right angle hook or engagement end 38, a second right angle hook 40 and an actuation protrusion or arm 42 that extends vertically from the end of the second hook 40 perpendicular relative to the glide portion 36. The engagement end 38 and the second hook 40 both extend approximately one quarter inch upward from the glide portion 36 and are oriented such that their ends face each other over the glide portion 36 as shown. Thus, as can be appreciated, the slide bolt 34 is adapted such that the glide portion 36 fits within and slides horizontally along the track 26 with the engagement end 38 and hook 40 directed upward above the track 26. In addition, a pair of threaded bores 43 are positioned along the centerline of the glide portion 36. The bores 43 are adapted to receive stop screws S-1 that extend from below the base plate 14, through the linear slot 32 and into the underside of the glide portion 36. The heads of the stop screws S-1 are sized to fit within the linear slot 32. When secured to the underside of the glide portion 36 in the bores 43, the stop screws S-1 limit the horizontal travel of the slide bolt 34 along the track 26 as the heads of the stop screws S-1 encounter their respective ends of the linear slot 32.

The door latch and strike apparatus 10 further includes a rigid metal cover 44 that is positioned over and attached to the mounting bracket 12 by the screw mounts M when the mounting bracket 12 is secured to the door D. The cover 44 is shaped to match and conform to the top of the base plate 14 over which the cover 44 is positioned. The cover 44 has a flat base 46, a perpendicularly upturned flat rear plate 48 and a parallel upturned flat front lip or plate 50. The rear plate 48 matches in shape the rear plate 16 of the mounting bracket 12. A set of three holes H-2 are formed in the rear plate 48 as shown and are positioned to correspond to the positioning of the holes H-1 in the rear plate 16. Like the holes H-1, the holes H-2 each have a diameter that is slightly larger than the shank diameter of the screw mounts M, such that the shanks of the screw mounts M can readily slide into the holes H-2 to secure the rear plate 48 to the rear plate 16 as can be readily understood.

The cover 44 is configured such that the base 46 fits flush against the upper surface of the base plate 14, and the rear plate 48 fits flush against the front face of the rear plate 16, when the cover 44 is secured to the mounting bracket 12 by the screws S-2. The front plate 50 projects upward from and perpendicular to the front edge of the base 46 where it gradually and uniformly arcs upward across its full length to a maximum height at its center point of approximately one half inch above the base 46.

As can be appreciated, when the slide bolt 34 is properly positioned in the track 26 as shown in FIGS. 1-6, and when the cover 44 is then secured to the mounting bracket 12, the base 46 of the cover 44 covers and thereby houses the slide bolt 34 in the track 26 while allowing the slide bolt 34 to laterally traverse within the track 26.

As can be seen in FIGS. 1-6, the door latch and strike apparatus 10 is configured to assemble together with a representative relatively flat and narrow foot-actuated remote door opener N. That is, the shanks of the screw mounts M are placed through the holes H-1 and H-2, as well as a set of three matching holes H-3 formed in a rear plate N-1 of the opener N. The three screws S-2 are threaded in and tightened into the screw mounts M, all as shown in FIG. 1. In this way, the opener N is concurrently secured by the screw mounts M to the rear plate 48 of the cover 44 along with the rear plates 16 and 48. Further, the opener N is shaped to generally match and correspond to the shape of the rear plate 48, with the opener N protruding forward from the rear plate 48 approximately three quarter inch, a width that is less than the distance between the rear plate 48 and the track 26. In this way, the opener N does not interfere with the horizontal motion and operation of the slide bolt 34 along the track 26. As can be seen in FIG. 1, the holes H-3 each comprise tubular protrusions that extend from the rear plate N-1 into the body of the opener N to allow for the mounting of springs as shown. Various other components of the representative opener N are depicted without numeration for general reference.

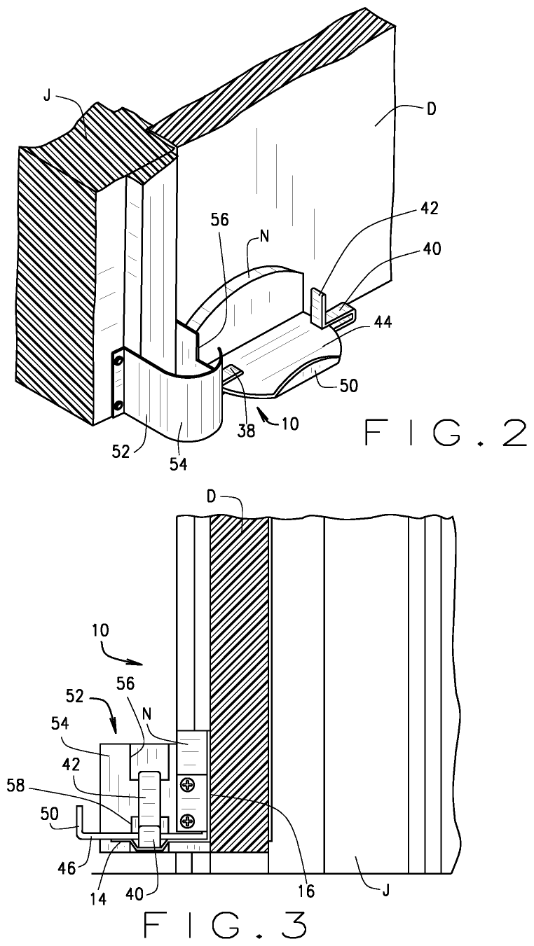

The door latch and strike apparatus 10 also includes a strike 52, formed from a vertically oriented metal plate having a height of approximately four inches. The strike 52 is adapted to secure to the base of the door jamb J in proximity to the mounting bracket 12 when the mounting bracket 12 is mounted to the door D (see FIGS. 2, 4 and 5). A set of four screws S-3 secure the strike 52 to the jamb J. The strike 52 has a uniform horseshoe-shaped portion 54 that extends outward from the jamb J approximately three inches. Two matching rectangular detent cut-outs, i.e., an upper cut-out 56 and a lower cut-out 58, are positioned on the side of the portion 54 facing the mounting bracket 12. Each of the cut-outs 56 and 58 is sized and shaped to readily receive the engagement end 38 of the slide bolt 34.

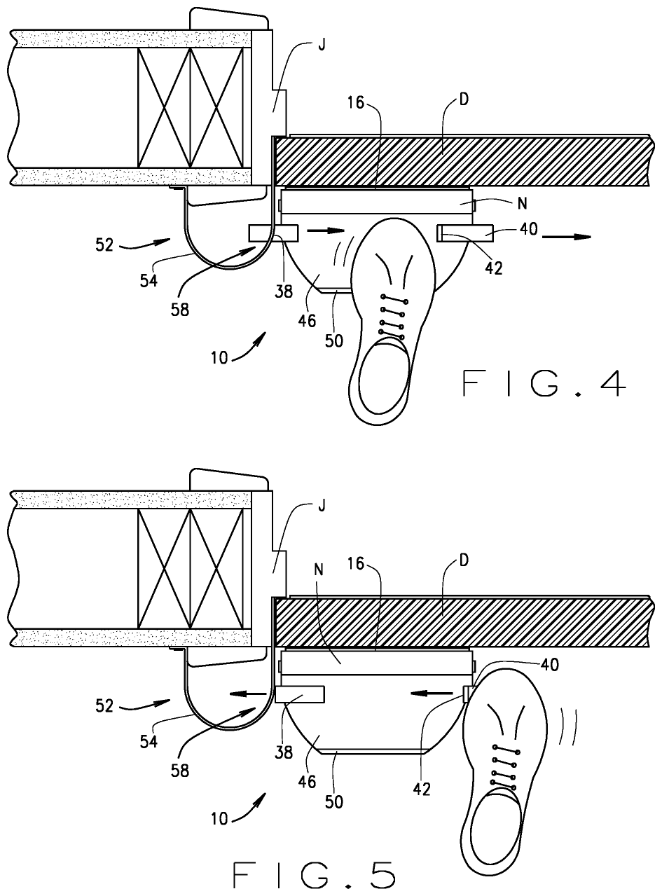

When the strike 52 is properly attached to the jamb J, the lower cut-out 58 receives the engagement end 38 when the slide bolt 34 is directed toward the strike 52, preferably by a user's foot applying force to the actuation arm 42 of the engagement end 38 (see FIG. 5). Once the engagement end 38 engages the lower cut-out 58, the door D will be held in place proximate the jamb J. The engagement end 38 can be disengaged from the lower cut-out 58 by directing the slide bolt 34 away from the strike 52, again preferably by a user's foot against the actuation arm 42 of the engagement end 38 (see FIG. 4).

One of ordinary skill in the art will recognize that the bores 43 for the stop screws S-1 are positioned along the underside of glide portion 36 of the slide bolt 34 so as to enable the slide bolt 34 to travel horizontally along the track 26 and at one end to fully engage the engagement end 38 with the strike 52, while at the other end fully disengage and clear the engagement end 38 from the strike 52. Further, the stop screws S-1 are positioned along the underside of glide portion 36 of the slide bolt 34 to keep the slide bolt 34 in the track 26 with horizontal travel limited by the stop screw S-1.

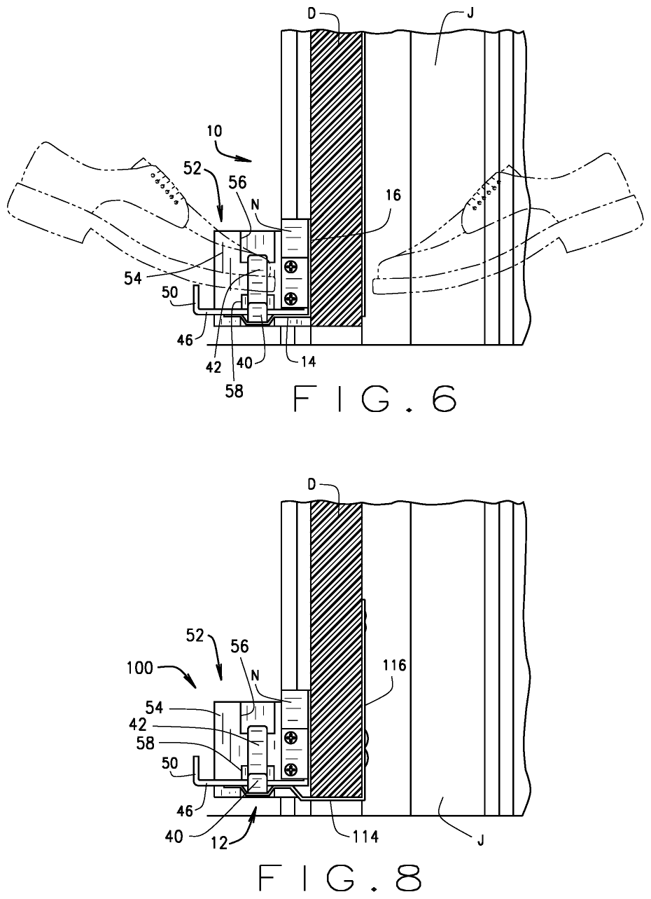

It will be appreciated that in practice, a user may operate the latch and strike apparatus 10 so as to enable the opening and closing of the door D by using a foot to push or urge the actuation arm 42 without the need to use hands. In particular, by using a foot to urge the engagement end 38 of the slide bolt 34 toward the door jamb J when the door D is substantially engaged with the jamb J, to thereby engage the engagement end 38 with the lower cut-out 58, the latch and strike apparatus 10 will secure the door D in its closed position proximate the jamb J. (See FIGS. 5, 6). Conversely, by using a foot to urge the engagement end 38 of the slide bolt 34 away from the door jamb J after the latch and strike apparatus 10 has engaged the lower cut-out 58, the latch and strike apparatus 10 will disengage the lower cut-out 58 and allow the door D to open away from the jamb J. (See FIGS. 4, 6). Moreover, the user's foot can be used to push against the mounting bracket 12 to close the door D, or the door D can be opened by using the foot to pull or tug on the lip or plate 50. (See FIG. 6).

Various other configurations of the novel door opener are also contemplated.

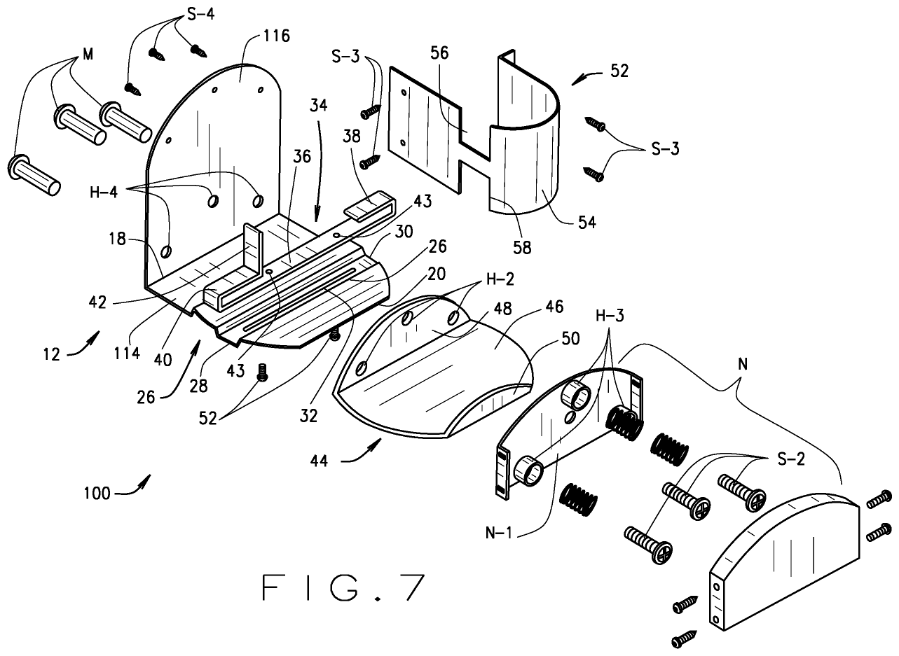

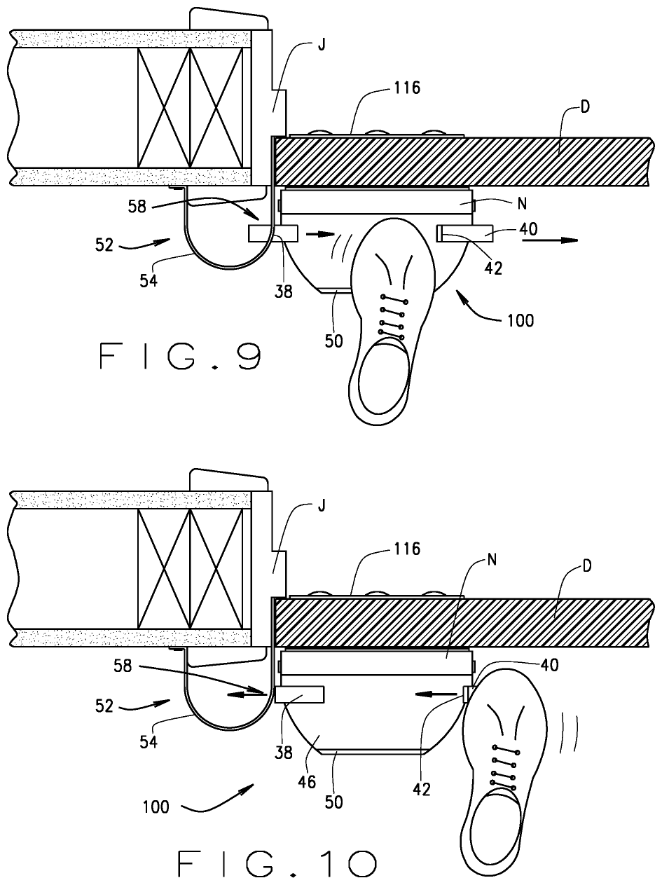

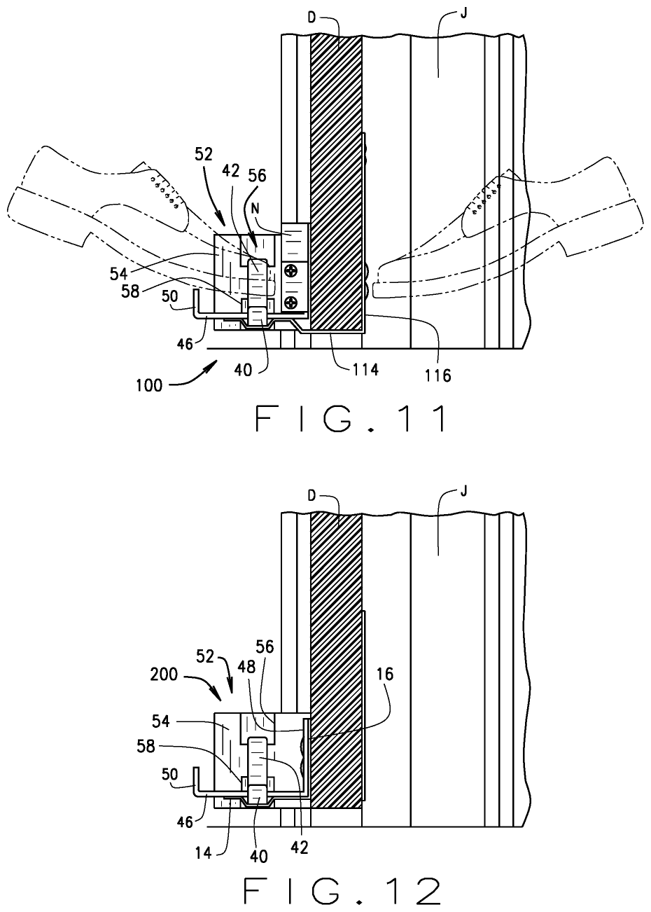

For example, FIGS. 7-11 depict a second embodiment 100 of the novel door latch and strike apparatus of the present disclosure. The door latch and strike apparatus 100 is configured the same as the door latch and strike apparatus 10, except that the embodiment 100 has a flat and rigid metal base plate 114 that extends horizontally under the door D, and a rear metal plate 116 that attaches to the face of the door D opposite the rear plate 48 of the cover 44. The base plate 114 has approximately the same width as the door D such that the rear plate 116 presses flush against the door D when the latch and strike apparatus 100 is fully assemble and secured to the door D. The rear plate 116 is taller than the rear plate 16 of embodiment 10 such that the rear plate 116 extends upward approximately six inches from the bottom of the door D before forming an upward-extending arc similar to the top of the rear plate 16. In addition, a set of three screws S-4 are each screwed through holes in the upper end of the rear plate 48 and into the face of the door D opposite the rear plate 48 to the door D. The rear plate 116 thereby forms a kick plate for the door D that is integrated into the door latch and strike apparatus 100. Of course, the rear plate 116 can be configured in a wide variety of shapes to provide a desired coverage over the lower portion of the door D.

As can be seen, the screw mounts M are inserted through a set of holes

H-4 in the rear plate 116. Like the holes H-1, H-2 and H-3, the holes H-4 each have a diameter that is slightly larger than the shank diameter of the screw mounts M, such that the shanks of the screw mounts M can readily slide into the holes H-2 to secure the rear plate 116 to face of the door D opposite the rear plate 48 as shown.

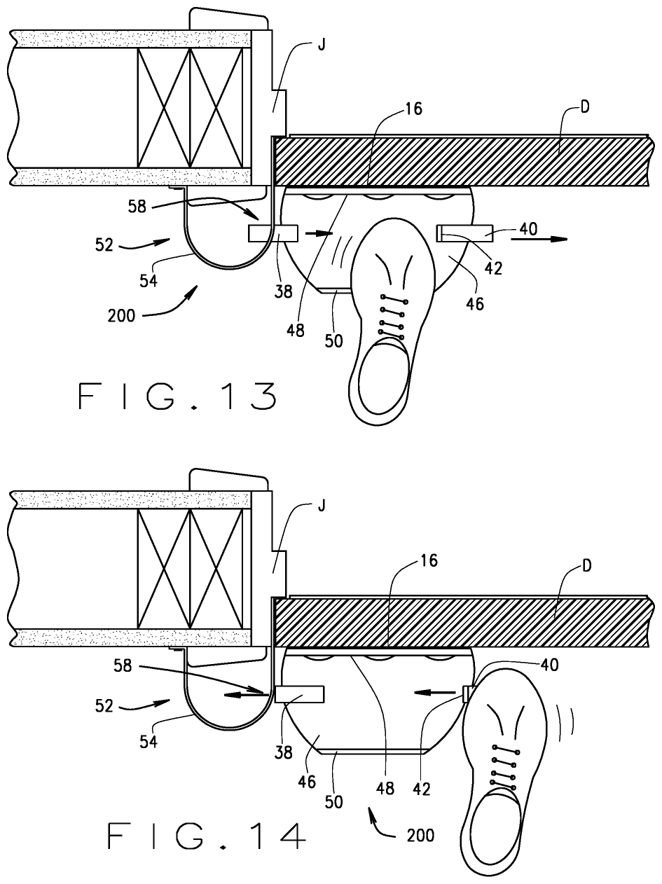

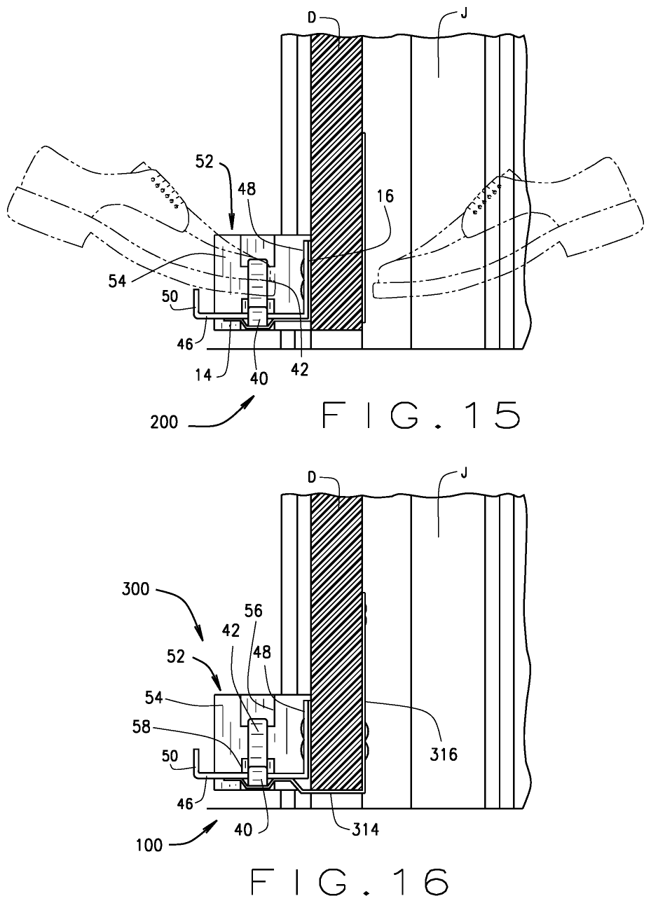

As another example, FIGS. 12-15 depict a third embodiment 200 of the novel door latch of the present disclosure in which the door latch is not integrated with an remote door opener, such as the door opener N. In this configuration, the screw mounts M are inserted from the front of the rear plate 48, such that the heads of the screw mounts M are pulled flush against the rear plate 48 when the screws S-2 are screwed into the screw mounts M through the door D and the rear plate 48.

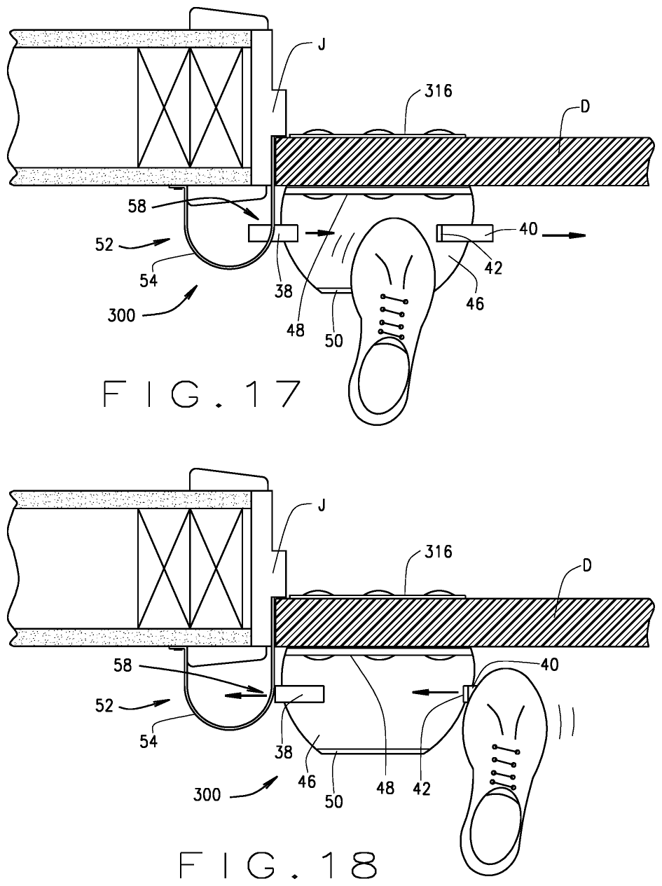

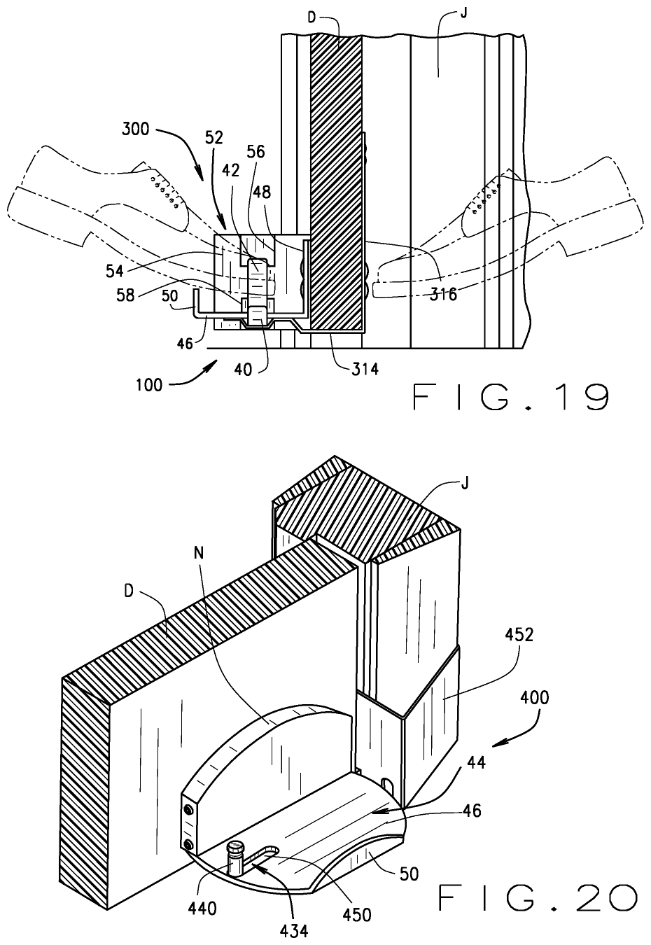

As another example, FIGS. 16-19 depict a fourth embodiment 300 of the novel door latch of the present disclosure, which is the same as the third embodiment 200 except it has a base plate 314 that extends under the door D, and a rear plate 316 that attaches to the face of the door D opposite the rear plate 48. In addition, the rear plate 316 is larger than in the first embodiment rear plate 10 such that the rear plate 316 forms a kick plate for the door D. Of course, the rear plate 316 can be configured in a wide variety of shapes to provide a desired coverage over the lower face of the door D.

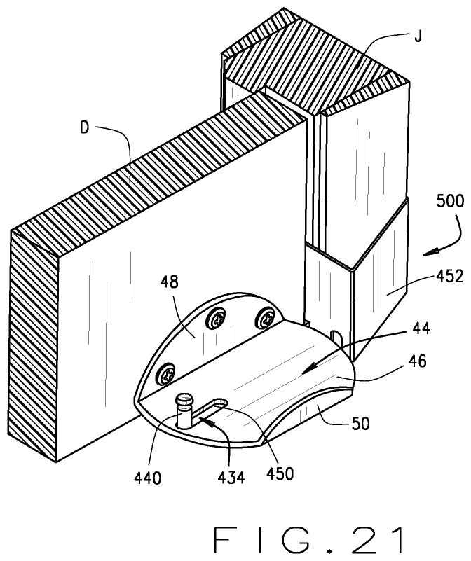

As another example, FIG. 20 depicts a fifth embodiment 400 of the novel door latch of the present disclosure with an integral remote door opener N, having a slide bolt 434 with an arm 440 that protrudes upward through a lateral and linear slot 450 in the cover 44. The fifth embodiment also depicts a strike 452 having an alternate configuration in which the horseshoe shaped portion 58 is reconfigured with an angular shape. The slot 450 is shaped and sized to control the lateral movement of the slide bolt 434 such that when the arm 440 is positioned within the slot 450 furthest from the strike 452, the slide bolt 434 is disengaged from the strike 452, and when the door D is closed against the jamb J and the arm 440 is positioned within the slot 450 nearest the strike 452, the slide bolt 434 is engaged with the strike 452.

As another example, FIG. 21 depicts a sixth embodiment 500 of the novel door latch of the present disclosure, which is the same as the door latch 400 but is not integrated with a remote door opener, such as the door opener N.

While I have described in the detailed description several configurations that may be encompassed within the disclosed embodiments of this invention, numerous other alternative configurations, that would now be apparent to one of ordinary skill in the art, may be designed and constructed within the bounds of my invention as set forth in the claims. Moreover, the above-described novel door latch, such as for example, the door latches 10, 100, 200, 300, 400 and 500, of the present invention can be arranged in a number of other and related varieties of configurations without departing from or expanding beyond the scope of my invention as set forth in the claims.

For example, the latch and strike apparatus of the present disclosure can be adapted to work without a strike plate, such as the strike 52, but instead the engagement end 38 of the strike bolt 34 can be configured to engage a detent or opening that has been cut or formed in the jamb J, or simply engage a brace or stop that is part of the jamb J construction.

By way of further example, the slide bolt 34 is not limited to the specific shape as depicted in the Figures, but can comprise a variety of shapes and sizes, such as for example, a peg, a piston, or a push rod, etc., so long as the device is capable of selectively engaging the door jamb J. Further, the actuation portion of the slide bolt 34 (or other engaging components) need not be specifically shaped as depicted in the disclosed embodiments, but may be configured in a wide variety of shapes and sizes so long as the actuation portion provides a platform or grip for the user's foot to readily operate the engaging mechanism of the latch and strike apparatus to engage the latch with the door jamb J.

Moreover, the mechanism latching the mounting bracket 12 to the door jamb J need not operate as a slide (e.g., the slide bolt 34), but can be mechanism based upon a variety of configurations, including for example, a screw, a pivot, twist bolt, a spring loaded button, an electrical or mechanical servo or stepper motor, etc., so long as the device can be attached to the mounting bracket 12 near the base of the door D and can be actuated by the user's foot to engage the latch with the door jamb J.

Moreover, the engaging mechanism (e.g., the slide bolt 34) can be fully powered or power assisted through the use, for example, of various biasing members, hydraulic or pneumatic pressure, or electric motors or drives.

Additional variations or modifications to the configuration of the novel door latch, such as for example, the door latches 10, 100, 200, 300, 400 and 500, of the present invention may occur to those skilled in the art upon reviewing the subject matter of this invention. Such variations, if within the spirit of this disclosure, are intended to be encompassed within the scope of this invention. Therefore, the description of the embodiments as set forth herein, and as shown in the drawings, is provided for illustrative purposes only and, unless otherwise expressly set forth, is not intended to limit the scope of the claims, which set forth the metes and bounds of my invention.

What is claimed is:

1. A door latch apparatus for attachment to a door, said door having a first face and a second face opposite the first face, said door having a substantially vertical edge between said first and second faces and a base along the bottom of the door between said first and second faces, said door having an open position and a closed position, said door being operatively associated with a jamb, said door edge facing the jamb when the door is in the closed position, said jamb having an upper end and a lower end with a detent proximate the lower end, said door engaging the jamb when in the closed position, the door latch apparatus comprising:
a. a mounting bracket attaching to the first face of the door, the mounting bracket being positioned proximate the base of the door and proximate the first edge of the door;
b. an elongated slide path oriented on said mounting bracket, said slide path extending generally horizontally and oriented generally parallel to the first face of the door;
c. a substantially rigid slide bolt having a glide portion, an engagement end and an actuation portion; said glide portion sliding generally horizontally along said slide path between a first position and a second position; the engagement end of the slide bolt extending from said mounting bracket and engaging the jamb detent when the door is substantially closed and the slide bolt is positioned in said first position along said slide path; the engagement end of the slide bolt being disengaged from the jamb detent when the slide bolt is positioned in said second position along said slide path; said actuation portion urging the slide bolt between said first and second positions.

2. The door latch of claim 1, further comprising a strike, the strike being attached to the jamb in proximity to the mounting bracket and comprising the detent, the engagement end of the slide bolt extending from said mounting bracket and engaging the strike detent when the door is substantially closed and the slide bolt is positioned in said first position along said slide path.

3. The door latch of claim 1, further comprising an elongated slide track positioned on said mounting bracket and oriented along said slide path.

4. The door latch of claim 3, further comprising a cover, said cover and mounting bracket forming a housing for the slide bolt, said housing retaining at least in part said glide portion of said slide bolt along said slide path.

5. The door latch of claim 4, wherein the housing comprises an opening, said opening facing the jamb detent, said engagement end protruding from the housing through said opening.

6. The door latch of claim 1, wherein said mounting bracket comprises a horizontal plate and said slide path is positioned on said horizontal plate.

7. The door latch of claim 3, wherein the slide track is formed in said mounting bracket.

8. The door latch of claim 1, wherein the actuation portion of the slide bolt comprises a protrusion.

9. The door latch of claim 1, further comprising a stop protruding from said slide bolt, said stop limiting the lateral travel of the slide bolt in said slide track.

10. The door latch of claim 1, further comprising a kick plate, said kick plate attaching to the second face of the door generally opposite said mounting bracket.

11. The door latch of claim 10, wherein said kick plate extends from said mounting bracket.

12. The door latch of claim 1, further comprising a biasing member, said biasing member urging the slide bolt toward one of said first and second positions along said slide path.

13. The door latch of claim 1, wherein a remote door opener is attached to the mounting bracket.

14. The door latch of claim 13, wherein the actuation member activates said remote door opener.

15. A door latch apparatus for attachment to a door, said door having a first face and a second face opposite the first face with a base along the bottom there between, said door having an open position and a closed position, said door being operatively associated with a jamb, said jamb having an upper end and a lower end with a detent proximate the lower end, said door engaging the jamb when in the closed position, the door latch apparatus comprising:
a. a mounting bracket attaching to the first face of the door, the mounting bracket being positioned proximate the base of the door and proximate the door jamb when the door is in its closed position;
b. a substantially rigid fastener having an engagement portion and an actuation portion; said fastener attached to said mounting bracket such that the engagement end of said fastener is movable between a first position and a second position; the engagement end of the fastener extending from said mounting bracket and engaging the jamb detent when the door is substantially closed and the engagement end is positioned in said first position; the engagement end of the fastener being disengaged from the jamb detent when the engagement end is positioned in said second position; said actuation portion urging the engagement end between said first and second positions.

16. The door latch of claim 15, further comprising a strike, the strike being attached to the jamb in proximity to the mounting bracket and comprising the detent, the engagement end of the fastener extending from said mounting bracket and engaging the strike detent when the door is substantially closed and the fastener is positioned in said first position.

17. The door latch of claim 15, further comprising a biasing member, said biasing member urging the slide bolt toward one of said first and second positions in the slide track.

18. The door latch of claim 15, wherein the fastener rotates about an axis, the engagement end of said fastener rotating about said axis between said first and second positions.

19. The door latch of claim 15, further comprising a biasing member, said biasing member urging the engagement end to rotate toward one of said first and second positions.

20. The door latch of claim 15, wherein a remote door opener is attached to the mounting bracket.
